(19) United States
(12) Patent Application Publication
(10) Pub. No.: US 2004/0165211 A1
(43) Pub. Date: Aug. 26, 2004

(54) Print authorization via an authorization device

(76) Inventors: William I. Herrmann, Eagle, ID (US); Bradley J. Anderson, Boise, ID (US); Bruce L. Johnson, Eagle, ID (US); Leonard T. Schroath, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/370,229

(22) Filed: Feb. 20, 2003

(51) Int. Cl. G06F 3/12; G06F 15/00; G06F 12/14; H04L 9/32

(52) U.S. Cl. 358/1.15; 713/171; 713/165; 713/184

(57) ABSTRACT

A method and system for improving secured access to data files stored on a printing device using an authorization device for receiving and transmitting an authorization code to a printing device for the release of secure data. An authorization code associated with secure data stored in a memory of a printing device is transmitted to an authorization device for later transmission to the printing device for the release of the secure data.

### FIELD OF THE INVENTION

The present invention relates to authorizing functions performed by printing devices. More particularly, the present invention relates to the use of a handheld device or other discrete authorization device to authorize execution of a function or print job for a printing device such as a printer, copier, multifunction device, or the like.

### BACKGROUND OF THE INVENTION

The proliferation of technology has resulted in a proliferation of printing devices and uses for printing devices. Printing devices include devices such as copiers, printers, multifunction devices, and the like. Copy machines, once a luxury, are commonly found in businesses, and may even be found in some homes for personal use. Printers, for printing data received from computers or other electronic devices, have also become commonplace in businesses, schools, and homes. The capabilities of printing devices such as these are expanding on a daily basis.

One feature frequently associated with printing devices is the capability of a printing device to store documents and data in a memory for delayed printing or on-demand printing initiated by a command executed on a control panel of the printing device. To provide such capabilities, printing devices are equipped with memory for storing data and releasing data for printing by a printing device at a specified time. For instance, printing devices may include storage memory such as random access memory (RAM), read-only memory (ROM), flash memory, hard disk memory, optical memory, or the like. A print job, or other data, stored in a printing device memory may be released from the memory and printed by the printing device. Typically, release of a print job, or other data, from the memory of a printing device requires a command or instruction issued by a computer connected to the printing device or initiated using the control panel of the printing device.

A print job stored in a memory of a printing device may also be assigned an authorization code, or security code, for regulating who may print the stored print job. Typically, an authorization code for a print job is created at the time the print job is created and stored in a memory of a printing device. For example, a network user sending a print job to a network printing device may assign an authorization code consisting of a personal identification number (PIN) to the print job. The print job, along with the necessary coding to identify the authorized PIN, is sent to the memory of the network printing device. When the network user decides to print the print job, he/she must first enter the designated PIN using the control panel of the network printing device. If the PIN is valid, the network printing device prints the print job. If the PIN is invalid, the print job is not released or printed. In this fashion, users may secure their print jobs and ensure that prying eyes do not read the documents or other data that they are printing. The ability to secure data is especially useful in enterprise situations where multiple users may share the same printing device. It is also useful because a network user may send a number of print jobs to a printing device and then retrieve all of the print jobs at one time when they are at the printing device.

Use of the secured and on-demand printing capabilities also helps to prevent the inadvertent misdelivery of print jobs. For instance, a network user's print jobs may be inadvertently removed from a printing device output tray with other print jobs. If an authorization code is required, however, the network user must be within the vicinity of the printing device to enter the necessary PIN to prompt printing. Thus, the network user may watch the printing of his/her print job and remove it with them when the print job is completed.

Some flaws do exist, however, to secured, on-demand printing. In particular, authorization codes are not necessarily secure and may be burdensome to remember when multiple print jobs, or other data, are sent to a printing device. The existing secure, on-demand printing processes require that a user select a PIN number to authorize the printing of a print job. The user must select a PIN, remember the PIN, and enter the PIN using a control panel of a printing device to release or print the stored print job. Where multiple print jobs are sent to one printing device, multiple PINs may need to be remembered. Because the user is required to memorize or otherwise record the PINs, small, easy to guess PIN numbers are frequently used to secure a document. This may lead to the infiltration of the security code and allow another user to guess the code and print a stored print job to which he/she is not entitled access. In other situations, the PIN number may be forgotten, oftentimes requiring the resending of the print job. Additionally, printing device control panels are frequently limited by the number of available control buttons, making it difficult to accept more sophisticated PINs or authorization codes. For example, the control panels of many printing devices are limited to numerical keypads; thus, any PIN must consist only of numbers. Letter and number combinations, which may be more secure, are not easily used with these types of devices.

Although secure on-demand printing capabilities for printing devices are being used more frequently, improved methods and systems for providing increased security protection for data and print jobs stored in a memory of a printing device are desirable.

### BRIEF SUMMARY OF THE INVENTION

In various embodiments of the present invention, an authorization code or codes and/or data file names stored on a handheld device may be used to release data from a printing device for performing printing functions. Authorization codes stored on the handheld device may also be used to provide permission to alter the settings of a printing device.

Using an authorization device for storing and communicating authorization codes provides an improved method for retrieving secure data from printing devices. The present invention allows larger, more complex authorization codes to be associated with print jobs because a user need not memorize each authorization code. Similarly, more complex authorization codes may be employed because an authorization code is not necessarily limited to those characters or numbers available on printing device control panels. Furthermore, multiple authorization codes may be stored by an authorization device, allowing a user to create and store multiple print jobs, or data, in a memory of a printing device before printing the print jobs, or data.

In addition, an authorization device may be used to store authorization codes that would allow a user to alter the settings of a printing device. For instance, the control panel settings may be locked at the printing device so that users are unable to alter the settings. A print job sent to the printing device could include one or more authorization codes that would allow the user to alter the printing device settings at the control panel. Use of the invention in this manner would assist in preventing changes to the printing device settings by unauthorized users.

### BRIEF DESCRIPTION OF THE SEVERAL VIEWS OF THE DRAWINGS

FIG. 1 is a diagram illustrating a system that may be used to carry out various embodiments of the present invention.

FIGS. 2 and 3 are block diagrams of the steps involved in an embodiment of the present invention.

### DETAILED DESCRIPTION OF THE INVENTION

In one embodiment of the present invention, a print job authorization code is synchronized with, or downloaded to, a discrete and physically independent authorization device, such as a personal digital assistant (PDA), such that the PDA may be used to transmit an authorization code to a printing device to release secure data from a memory of the printing device. Authorization device as used in this document refers to a device that is separate and distinct from the printing device. In another embodiment of the present invention, both a file name and an authorization code associated with the file name are downloaded to an authorization device for releasing secure data from a memory of the printing device. Authorization codes for allowing a user to alter or change the device settings of a printing device may also be downloaded to the handheld device. Other embodiments also exist and will be described in greater detail herein.

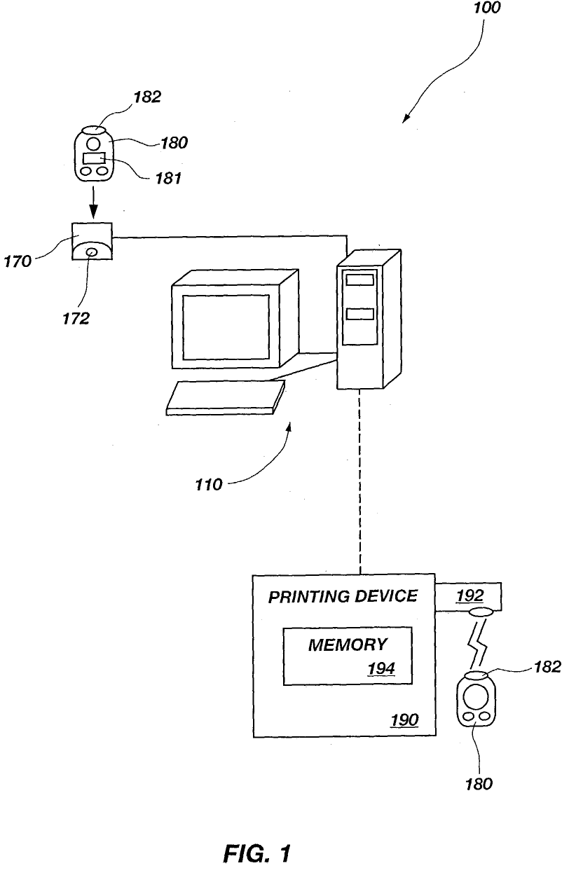

A diagram of a system 100 that may be used to carry out various embodiments of the present invention is illustrated in FIG. 1. A computer system 110 may be equipped to communicate with a PDA 180 and one or more printing devices 190.

Computer system 110 may include a computer workstation connected to a network or enterprise system, a personal computer, or a laptop computer that may be connected to and from a network or enterprise system. Computer system 110 may include one or more central processing units (CPU), memories, storage devices, display devices, input devices, communication ports, or the like, as known.

A PDA 180 may communicate with computer system 110 in any variety of ways. In one embodiment, PDA 180 may communicate with computer system 110 through a PDA communications device 170. In another embodiment, PDA 180 may communicate with computer system 110 using infrared, radio frequency, or other wireless communications. Similarly, PDA 180 may communicate with computer system 110 using an Internet or modem connection.

Generally, a software package, or program, may be included with a PDA 180 for installing in a memory or on a storage device of a computer system 110. PDA 180 software packages typically facilitate communications between the PDA 180 and the computer system 110. Software programs for storing, manipulating, and communicating data between a PDA 180 and a computer system 110 are well known and frequently used for both business and personal use. A software package may provide the necessary methods and functions for initiating, controlling, and operating communications between a PDA 180 and a computer system 110.

One embodiment for communicating data to a PDA 180 involves a PDA communication device 170 connected, or in communication with, computer system 110. Typically, a PDA communication device 170, such as a PDA cradle, communicates with computer system 110, or a software package operating on computer system 110, via a hardwire such as a serial cable, USB connection, firewire connection, or other communications port. The PDA communications device 170 may be compatible with a single PDA 180, or designed to operate with one or more types of PDAs 180 for providing communication between computer system 110 and a PDA 180. For example, a JORNADA® PDA, offered by Hewlett Packard, may include a cradle, or other PDA communication device 170, that allows the JORNADA® to communicate with a computer system 110. Placement of a PDA 180 in a PDA communications device 170 may open a communication link between computer system 110 and PDA 180. Alternatively, initiation of a communication link between a PDA 180 and computer system 110 may require placement of PDA 180 in PDA communications device 170, followed by a user-initiated command to begin communications between the devices.

A PDA communications device 170 may include a command button 172 for initiating communications between a PDA 180 and computer system 110 through the PDA communications device 170. Selection of command button 172 by a user typically activates, or opens, a communication link between a PDA 180 and a software package resident on computer system 110 for transfer of data between PDA 180 and the computer system 110. Alternatively, communication between a PDA 180 and computer system 110 may be initiated by a command from computer system 110 or a software package operating on computer system 110.

One approach utilizes software resident on both computer system 110 and PDA 180. In such a configuration, the software on computer system 110 and the software on PDA 180 are configured analogous to name or business card storage and beaming principles appreciated by those of ordinary skill in the art. Namely, the computer system 110 upon the execution of a print command to a printing device, generates a print job “business card”, including the authorization code for the print job, in the database of the computer system 110. The print job “business card” is then forwarded to PDA 180 during a synchronization process between computer system 110 and PDA 180. PDA 180.

A PDA 180 may also communicate with computer system 110 using wireless communications such as infrared or radio frequency transmissions. Computer system 110 may be manufactured or otherwise adapted to include wireless communications. In order for PDA 180 and computer system 110 to communicate using wireless transmissions, both PDA 180 and computer system 110 must be equipped with compatible wireless communications devices such as infrared, laser, or radio frequency transmitters and receivers. PDA 180 is illustrated with an infrared port 182 in FIG. 1. Use of wireless communications devices such as these with PDAs 180 or other handheld devices is known and shall not be explained further.

Alternatively, PDA 180 may communicate with computer system 110 using an Internet or other remote connection, such as a modem connection.

Data may be transmitted between a PDA 180 and a computer system 110 in any number of ways. Typically, a PDA 180 is designed to communicate through a communication link with an associated software package operating on a computer system 110 such that the PDA 180 and software package maintain similar databases of information. Typically, a software package manages a database, or a number of databases, in the same manner as a PDA 180 manages data. A single software package may be used to manage one or more PDAs 180. The initiation of communications between a PDA 180 and a software package is commonly referred to as synchronizing (or “syncing” for short) the PDA 180 with the software package or computer system 110. When a PDA 180 is synchronized with a computer system 110, any data stored on the PDA 180 is synchronized with the data stored by the software package on the computer system 110. If the data stored on the PDA 180, or by a software package, has changed, corresponding data stored by the other device may be updated or backed up during a synchronization. Methods for syncing devices, such as PDAs 180, with computer systems 110 are known.

Other communications may also occur between a PDA 180 and a computer system 110. For instance, data from a computer system 110 may be directly transfer red or downloaded to a PDA 180. Similarly, a software package stored on a computer system 110 may automatically send data to a PDA 180 in communication with computer system 110. Data received by a PDA 180 may be stored in a memory of the PDA 180 for later retrieval or transmission. Using methods such as synchronization or direct data downloading, an authorization code for a print job may be communicated from computer system 110 to a PDA 180 for storage.

Print job authorization code may also be directly loaded into PDA 180 by way of manual data entry software on PDA 180. Such PDA software allows a user to manually enter authorization codes as received from at the computer system 110 and enter and save them within PDA 180 for subsequent wireless divulgence at printing device 190. An example of such manual storage software includes “IrKey 1.2” available from its manufacture, Tapspring Co. Ltd. of Taiwan.

System 100 may also include a printing device 190, such as a printer, a copier, or a multifunction device for receiving, storing, and printing print jobs or other data sent from computer system 110 to printing device 190. Typically, printing device 190 may include a memory 194, storage media, or other devices or capabilities for storing data received from computer systems 110 in communication with printing device 190. Printing device 190 may also include communications capabilities for both wired and wireless communications. For instance, printing device 190 may be equipped with a PDA communications device similar to PDA communications device 170 for communicating with PDAs 180 using wire-based communications. Alternatively, printing device 190 may include wireless communications capabilities, such as an infrared communications port 192 or radio frequency transmitter/receiver (not shown), for allowing wireless communications between printing device 190 and other devices.

An improved method for authorizing use of printing devices 190 according to the present invention may be accomplished with illustrated system 100. For example, a user creating a print job to be sent from computer system 110 to printing device 190 may wish to store the print job in a memory 194 of printing device 190 until a later time when he/she plans on retrieving the print job from the printer. To ensure security, the user selects to store the print job with an authorization code, such that only a user having the proper authorization code may print the print job from the printing device 190. An authorization code may be created by the user or randomly created by the computer system 110 or printing device 190.

The authorization code may include, but is not limited to, passwords, personal identification numbers, encryption keys, or other systems and methods for providing authorization. In any event, the authorization code must be repeatable in order to retrieve the print job from memory 194 of the printing device 190. To avoid memorizing the authorization code, the user may choose to download or synchronize the authorization code to his/her PDA 180 or other authorization device. Placing PDA 180 in a PDA communications device 170 and initiating synchronization by pressing the command button 172, computer system 110 downloads into a PDA memory 181 a created authorization code associated with the print job to PDA 180. Once synchronization is complete, the PDA 180 holds, or stores, the authorization code in a memory for later retrieval. Alternatively, an authorization code may be sent directly to a PDA 180 without synchronization of all of the information stored on the PDA 180. For instance, print driver software used to create a print job for a printing device 190 may include a set of commands for automatically transmitting an authorization code to a PDA 180, or other authorization device, in communication with computer system 110. Thus, when a print job is sent to printing device 190, an authorization code to release the print job is automatically downloaded to PDA 180. Other synchronization commands or systems may also be used to transfer data and authorization codes to a PDA 180.

At a later time, the user may wish to retrieve the print job from printing device 190. Selecting the desired print job from a control panel of the printing device 190, the user may be prompted for an authorization code to print the selected print job. Having the PDA 180, the user may communicate the authorization code to the printing device 190 from PDA 180, using either wired or wireless communications. For example, aligning an infrared port 182 of PDA 180 with infrared port 192 of printing device 190 may allow PDA 180 and printing device 190 to communicate. Using PDA 180, the user may initiate communication between PDA 180 and printing device 190 wherein the authorization code stored in the memory of PDA 180 is communicated to printing device 190. Upon validation of the authorization code for a certain stored print job, printing device 190 may print the print job for the user.

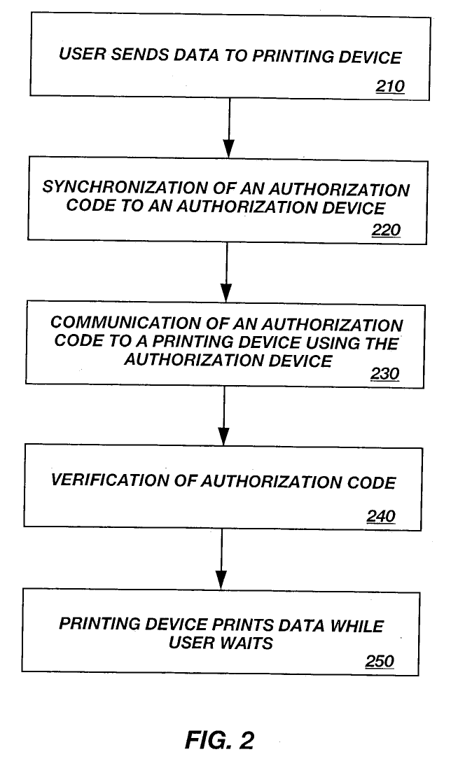

A block diagram of the steps involved in the methods of the present invention is illustrated in FIG. 2. The process begins with a user sending data to a printing device 210, where the data is stored in a memory until retrieved with an authorization code. An authorization code for retrieving the stored data is downloaded, or communicated, to an authorization device 220. Downloading may occur by synchronization, writing data to an authorization device, or other method as known. Following successful synchronization, the authorization device may be used to communicate an authorization code to a printing device 230. The printing device verifies the authorization code and matches the authorization code with the desired data 240. Once the authorization code is verified, the printing device prints the desired data while a user waits 250.

Data may be sent to a printing device 190 using any number of methods. As previously illustrated, a stand-alone or networked computer system 110 may be used to send data to a printing device 190. Additionally, data may be sent to a networked printing device 190 using an Internet connection, a wireless connection (such as radio frequency transmission), an energy transmission (such as infrared or laser transmission), or by any other communications method capable of transmitting data in an electronic or digital format.

Any number of authorization devices may be used for synchronizing an authorization code to an authorization device 220. The use of a PDA as an authorization device has been previously described in detail. Other authorization devices may also be used. For instance, combination PDA/cellular phones are becoming popular and may operate in a similar manner as PDAs. Cellular phones, pagers, laptop computers, handheld computers, calculators, watches, handheld game devices or other devices equipped with capabilities to communicate electronic or digital data may also be used. Preferably, authorization devices may be handheld devices, easily carried and used with printing device 190 communications ports. More preferably, the authorization device includes wireless communication capabilities.

As previously discussed, authorization codes may be transmitted, or communicated, to a printing device 190 using wired communications, wireless communications, or remote communications. Wired communications include communications of an authorization code over a wire-based communication line such as a serial port cable, USB cable, FireWire, or the like. Preferably, however, an authorization code is transmitted from an authorization device to a printing device 190 using a wireless communication such as an infrared transmission or radio frequency transmission. Alternatively, communication between an authorization device may occur using a remote connection such as an Internet connection or direct modem connection between the authorization device and printing device 190.

An authorization code may be verified 240 by a printing device using methods currently established and used with printing devices 190 to verify authorization codes, such as encoding and encryption methods understood by those of ordinary skill in the art. The use of authorization devices to store authorization codes provides increased security because larger, more complex authorization codes may be associated with secure data stored in printing devices.

It is understood that other devices capable of communicating with a computer system 110 or printing device 190 and storing an authorization code in a memory may be substituted for the PDA 180 in the embodiments of the present invention. The only requirement for an authorization device is that it is able to store or retrieve an authorization code from a memory or other storage device and transmit the authorization code to a printing device, via wired transmissions, wireless transmissions, or otherwise. For example, a cellular phone equipped with an infrared port for transmitting and receiving data may be used to carry out the embodiments of the present invention. A user sending a print job from a computer system equipped with an infrared communications port may position a cellular phone with an infrared communications port for receiving a print job authorization code from the computer via an infrared communication.

Once received, the user may carry the cellular phone to a printing device storing the print job. Aligning the infrared communications port of the cellular telephone for communication with an infrared communications port of the printing device storing the print job, a communications link between the two devices may be established. Using a command on the cellular phone, or the printing device, the user may transmit the print job authorization code to the printing device with an infrared transmission. Verifying the authorization code, the printing device may retrieve and print the saved print job associated with the received authorization code. Thus, using a cellular telephone, a user is provided with an improved method for authorizing print jobs from a printing device.

In another embodiment of the present invention, an authorization device may store an authorization code as well as a file name for the data associated with the authorization code and stored in a printing device 190. To improve security and memory allocation through file naming, a data file sent to storage media associated with a printing device 190 may be given a random file name. Either computer system 110 or printing device 190 may define the file name. Both the file name and the associated authorization code may be communicated to and stored by the authorization device. A user may associate a different, or recognizable, name to the data file stored in the authorization device.

To retrieve the secure data from the printing device 190, a user may initiate communications between the authorization device and printing device 190. Selecting the desired data file by an identifying name stored in the user's authorization device, the random data file name and authorization code associated therewith may be communicated to the printing device 190. The printing device 190 may retrieve the data file and the authorization code may be compared to the authorization code received from the authorization device. If the authorization code of the data file corresponds to the received authorization code, the data may be printed or otherwise manipulated.

For example, a user, having sent a cover letter associated with an authorization code to a printing device, downloads and stores a random file name, representing the file stored by printing device 190, and the authorization code in an authorization device. The user may use the authorization device to assign an identifying name, “cover letter,” to the random file name and authorization code stored in the authorization device. When the user desires to retrieve the cover letter data from the printing device, he/she may select the “cover letter” identification from the authorization device, which in turn transmits the random file name and authorization code associated with the identifying name to the printing device 190. If the authorization code is verified for the specified file name, the cover letter data may be printed or otherwise manipulated by printing device 190.

In another embodiment of the present invention, a user may create a document, or other data, on a computing device remote from a network and transmit the data to a printing device 190 associated with the network for storage and later printing. To secure the data, the user may assign an authorization code to the data sent to the printing device 190. Once sent, the authorization code may be stored on the device being used to send the data to the printing device 190. For instance, a user accessing a network via the Internet, a modem connection, or wireless connection with a computing device, such as a laptop computer, a PDA, or other handheld computing device, may send a data file to a network printing device 190. An authorization code associated with the data file may be stored in a memory of the computing device for later access. Storage and spooling of print jobs as well as associating an authorization code with a print job is described in references associated with a “Private Jobs” feature of HP LaserJet Printers, and in particular, with respect to 4000 Series and 5000 Series models, and are not further described herein. Upon returning to the office, the user may use the computing device to transmit the authorization code to the printing device 190 storing the secure file. Transmission between the computing device and the printing device 190 may occur either by wired or wireless communications.

Similarly, a user sending multiple print jobs, or other data, to a printing device may store a set of authorization codes on computer system 110 and perform a bulk download of authorization codes to an authorization device at a later time. For instance, a user may send a number of print jobs from a computer system 110 to a printing device 190 over the course of a week. Not wanting to print the print jobs until the last day of the week, the user may store the authorization codes associated with the print jobs in a memory of the computer system 110. On the day for printing, the user may initiate a batch, or group, download of all of the stored authorization codes from the memory of the computer system 110 to an authorization device. Each of the authorization codes may be stored in the authorization device and used to release the associated print jobs from printing device 190 when desired.

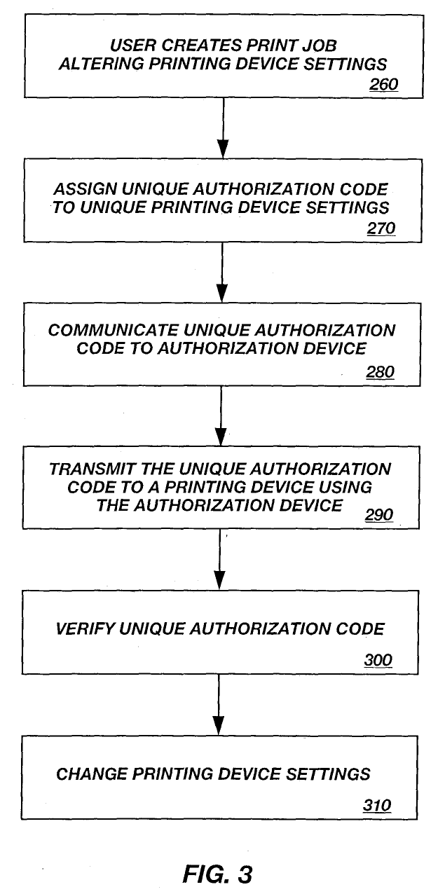

In another embodiment of the present invention, illustrated in FIG. 3, a printing device 190 may include a set of operating codes or settings that should not be changed. For instance, the printing device 190 may include a number of default settings for the type of paper to be used, the size of font to be used, the quality of document to be produced and so on. Default settings are commonly used with printing devices 190 and oftentimes it is desirable to lock out the ability to change the default settings, especially in an enterprise environment. Using the present invention, an authorization code or codes may be integrated with a control system of the printing device 190 that prevents users who do not have the proper authorization code from altering the default settings of the printing device 190. If a user creates 260 a print job that requires an alteration of the printing device's 190 default settings, a unique authorization code for allowing access to change the printing device 190 settings is created and assigned 270. The unique authorization code is communicated 280 to the PDA 180 and used, following verification 300 of the unique authorization code, by a user to gain access and change 310 the printing device's 190 settings. Alternatively, a user could use a software program to request permission to alter the default settings of a printing device 190. If authorization is granted, an authorization code allowing the user to alter the printing device 190 settings would be downloaded to the user's PDA 180. Using the PDA 180, the user could transmit 290 the authorization code for altering the printing device 190 settings to the printing device in order to gain the ability to alter the default settings for a particular print job.

Overall, the methods and systems of the present invention provide an improved data security system for use with secure data printing from various printing devices. The use of an authorization device allows larger, more complex authorization codes to be created and used to secure data stored in a memory of a printing device or to secure the control settings of a printing device. Furthermore, use of an authorization device to store authorization codes eliminates the need for a user to memorize authorization codes, providing a more user-friendly environment for utilizing authorization codes and authorization devices.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method for authorizing a print job from a printing device, comprising:
sending at least one print job from a computer system to said printing device;
communicating at least one authorization code to an authorization device for releasing said at least one print job from said printing device; and
communicating said at least one authorization code from said authorization device to said printing device for authorizing printing of said at least one print job.

2. The method of claim 1, further comprising printing said at least one print job.

3. The method of claim 1, wherein said printing device is selected from the group consisting of a printer, a copier, and a multifunction device.

4. The method of claim 1, wherein said authorization device is selected from the group consisting of a personal digital assistant, a cellular phone, a combination cellular phone/personal digital assistant, a pager, a calculator, a handheld game device, a watch, a laptop computer, and a handheld computer.

5. The method of claim 1, wherein said communicating at least one authorization code to an authorization device for releasing said at least one print job from said printing device comprises:
placing said authorization device in a cradle in communication with said computer system via a cable connection;
initiating communication between said authorization device and said computer system; and
downloading said at least one authorization code to said authorization device.

6. The method of claim 1, wherein said communicating at least one authorization code to an authorization device for releasing said at least one print job from said printing device comprises transmitting said at least one authorization code to said authorization device via a wireless transmission.

7. The method of claim 1, wherein said at least one authorization code comprises an authorization code selected from the group consisting of a password, a personal identification number, a personal identification code, an encrypted key, and a set of encryption keys.

8. The method of claim 6, wherein said communicating said at least one authorization code from said authorization device to said printing device comprises transmitting said at least one authorization code from said authorization device to said printing device via a wireless transmission selected from the group consisting of an infrared transmission and a radio frequency transmission.

9. A method for accessing a data file stored in a printing device, comprising:
associating a unique authorization code to said data file for limiting access to said data file;
saving said data file and said unique authorization code to a storage media associated with said printing device;
saving said unique authorization code to an authorization device; and
transmitting said unique authorization code from said authorization device to said printing device for authorizing access to said data file.

10. The method of claim 9, wherein said saving said data file and said unique authorization code to a storage media associated with said printing device comprises saving said data file and said unique authorization code to a memory associated with said printing device, wherein said memory is selected from the group consisting of random-access memory, flash memory, hard disk memory, optical memory, and read only memory.

11. The method of claim 9, wherein said saving said unique authorization code to an authorization device comprises saving said unique authorization code to a device selected from the group consisting of a personal digital assistant, a cellular phone, a combination cellular phone/personal digital assistant, a pager, a laptop computer, a handheld computer, a calculator, a handheld game device and a watch.

12. The method of claim 9, wherein said saving said unique authorization code to an authorization device comprises:
establishing a communications link between a computer system and said authorization device;
downloading said unique authorization code from said computer system to said authorization device; and
saving said unique authorization code in a memory of said authorization device.

13. The method of claim 9, further comprising creating said data file on a computer system.

14. The method of claim 9, further comprising transmitting said unique authorization code to said authorization device before saving said unique authorization code to said authorization device.

15. The method of claim 14, wherein said transmission of said unique authorization code to said authorization device is accomplished using wire-based transmissions.

16. The method of claim 14, wherein said transmission of said unique authorization code to said authorization device is accomplished using wireless transmissions.

17. The method of claim 14, wherein said transmission of said unique authorization code to said authorization device is accomplished using infrared transmissions.

18. The method of claim 9, wherein said unique authorization code comprises an authorization code selected from the group consisting of a password, a personal identification number, a personal identification code, an encrypted key, and a set of encrypted keys.

19. A system for transmitting authorization codes to a printing device for releasing secure data stored by said printing device, comprising:
a printing device for storing secure data received from a computer system until said secure data is released by at least one authorization code transmitted to said printing device by an authorization device;
a computer system for sending secure data to said printing device for storage and for communicating said at least one authorization code for releasing said secure data from said printing device; and
an authorization device for receiving said at least one authorization code from said computer system and for transmitting said at least one authorization code to said printing device for releasing said secure data.

20. The system of claim 19, wherein said authorization device is selected from the group consisting of a personal digital assistant, a cellular phone, a combination cellular phone/personal digital assistant, a pager, a calculator, a handheld game device, a watch, a laptop computer, and a handheld computer.

21. The system of claim 19, wherein said authorization device comprises:
a memory for storing said at least one authorization code; and
at least one communications device for communicating with said computer system and said printing device.

22. The system of claim 21, wherein said at least one communications device is selected from the group consisting of an infrared communications device, a radio transmission/receiver communications device, a personal digital assistant cradle, and a wire-based communications device.

23. A method for authorizing changes to control settings of a printing device, comprising:
assigning a unique authorization code to said control settings for preventing alterations of said control settings without said unique authorization code;
communicating said unique authorization code to an authorization device; and
transmitting said unique authorization code from said authorization device to said printing device for allowing alteration of said control settings.

24. The method of claim 23, further comprising storing said unique authorization code to a storage device associated with said printing device before communicating said unique authorization code to said authorization device.

25. A computer-readable medium having computer-executable instructions for authorizing a print job from a printing device, said computer-executable instructions for performing acts comprising:
sending at least one print job from a computer system to said printing device;
communicating at least one authorization code to an authorization device for releasing said at least one print job from said printing device; and
communicating said at least one authorization code from said authorization device to said printing device for authorizing printing of said at least one print job.

26. The computer medium of claim 25, further comprising computer readable instructions for printing said at least one print job.

27. The computer medium of claim 25, wherein said computer-executable instructions for communicating at least one authorization code to an authorization device for releasing said at least one print job from said printing device comprises computer-executable instructions for transmitting said at least one authorization code to said authorization device via a wireless transmission.

28. A computer-readable medium having computer-executable instructions for accessing a data file stored in a printing device, said computer-executable instructions for performing acts comprising:
associating a unique authorization code to said data file for limiting access to said data file;
saving said data file and said unique authorization code to a storage media associated with said printing device;
saving said unique authorization code to an authorization device; and
transmitting said unique authorization code from said authorization device to said printing device for authorizing access to said data file.

29. The computer-readable medium of claim 28 wherein said computer-executable instructions for performing said saving said data file and said unique authorization code to a storage media associated with said printing device comprises computer-executable instructions for saving said data file and said unique authorization code to a memory associated with said printing device, wherein said memory is selected from the group consisting of random-access memory, flash memory, hard disk memory, optical memory, and read only memory.

30. The computer-readable medium of claim 28, wherein said computer-executable instructions for saving said unique authorization code to an authorization device comprises computer-executable instructions for:
establishing a communications link between a computer system and said authorization device;
downloading said unique authorization code from said computer system to said authorization device; and
saving said unique authorization code in a memory of said authorization device.

31. The computer-readable medium of claim 28, further comprising computer-executable instructions for creating said data file on a computer system.

32. The computer-readable medium of claim 28, further comprising computer-executable instructions for transmitting said unique authorization code to said authorization device before saving said unique authorization code to said authorization device.
